(19) United States
(12) Patent Application Publication
(10) Pub. No.: US 2011/0299596 A1
(43) Pub. Date: Dec. 8, 2011

(54) Fractional motion estimation method with adaptive mode selection

(75) Inventors: Jiun-In Guo, Chiayi County (TW); Chih-Chuan Yang, Chiayi County (TW); Yao-Chang Yang, Chiayi County (TW)

(73) Assignee: NATIONAL CHUNG CHENG UNIVERSITY, MIN-HSIUNG (TW)

(21) Appl. No.: 12/805,902

(22) Filed: Aug. 24, 2010

(30) Foreign Application Priority Data
Jun. 2, 2010 (TW) 99117786

(51) Int. Cl. H04N 7/26

(52) U.S. Cl. 375/240.16; 375/E07.125

(57) ABSTRACT

A fractional motion estimation method including the steps of categorizing search modes of the macroblock into a single mode, a reduced mode, and a full mode; determining a search mode of a to-be-process macroblock according to a predetermined condition; and conducting a fractional motion estimation of a to-be-estimated pixel according to the search mode determined in the aforesaid step. Therefore, the fractional motion estimation method can have the adaptive mode selection to spare some parts of computation for low throughput. In other words, it can effectively enhance efficiency of hardware, to lower power consumption, and to maintain consistent image quality.

### BACKGROUND OF THE INVENTION

1. Field of the Invention

The present invention relates generally to an image processing technique, and more particularly, to a low complexity fractional motion estimation algorithm for multimedia video coding applications.

2. Description of the Related Art

Among the image processing techniques, for example, U.S. Pat. Nos. 7,408,988 and 7,580,456 each disclosed something about a fractional pixel motion estimation method. In the field of BACKGROUND of the latter patent, the integer pixel motion estimation and the fractional pixel motion estimation under the video coding standard H.264 were recited.

In H.264/AVC encoding, the fractional pixel motion estimation method is to primarily search 41 blocks of different sizes including one 16×16 block, two 16×8 blocks, two 8×16 blocks, four 8×8 blocks, eight 8×4 blocks, eight 4×8 blocks, and sixteen 4×4 blocks. After the search for all of the blocks, a 16×16 macroblock of optimal estimation is generated.

According to the aforesaid method, while the search for each of the blocks is performed, it is necessary to carry out the interpolation computation of the pixels in the reference, e.g. the previous frame or image, to acquire the required fractional pixels, then to search each pixel within the corresponding predetermined search range, and finally to get a sum of absolute transformed differences (SATD) of each of the aforesaid pixels. After the search for all of the pixels, the pixel of minimum SATD and the corresponding motion vector (MV) can be obtained. After the search for all of the 41 blocks is done, the best combination can be selected for encoding.

In both of the above-identified two patents, the search is executed for each of the blocks and no reduction mode is applied to the 41 blocks, such that the whole process is complex and only one combination mode is selected at last to need further improvement.

### SUMMARY OF THE INVENTION

The primary objective of the present invention is to provide a fractional motion estimation method, which adopts the adaptive mode selection to decrease computation complexity, to effectively enhance efficiency of hardware, to lower power consumption, and to maintain consistent image quality.

The foregoing objective of the present invention is attained by the fractional motion estimation method including the steps of a) categorizing search modes of the macroblock into a single mode, a reduced mode, and a full mode; only 16×16 blocks are searched in the single mode, only 16×16 blocks, 16×8 blocks, 8×16 blocks and 8×8 blocks are searched in the reduced mode, and 16×16 blocks, 16×8 blocks, 8×16 blocks, 8×8 blocks, 8×4 blocks, 4×8 blocks, and 4×4 blocks are searched in the full mode, each of the blocks being composed of a plurality of integer pixels; in the 4×4 blocks as an example, there are 16 integer pixels; b) determining a search mode for a to-be-processed macroblock according to a predetermined condition as follows; select the single mode if the best mode of the integer pixel motion estimation of the to-be-processed macroblock is 16×16 and the mode of its predetermined adjacent macroblock is 16×16; select the reduced mode if the best mode of the integer pixel motion estimation of the to-be-processed macroblock is not 16×16 and the mode of its predetermined adjacent macroblock is 16×16; select the reduced mode if the best mode of the integer pixel motion estimation of the to-be-processed macroblock is one of 16×16, 16×8, and 8×16 modes and the mode of its predetermined adjacent macroblock is one of 16×16, 16×8, and 8×16 modes, or (4) select the full mode if the best mode of the integer pixel motion estimation of the to-be-processed macroblock and the mode of its predetermined adjacent macroblock are both different from the aforesaid three conditions; c) conducting a fractional motion estimation of a to-be-estimated pixel according to the search mode determined in the step b); the fractional motion estimation can be done by accessing a pixel located in a reference and corresponding to the to-be-estimated pixel, performing an interpolation computation of such two pixels to get a half pixel and a quarter pixel, calculating the SATD and the MV cost of each of the pixels (integer pixel, half pixel, and quarter pixel) within a predetermined search range corresponding to the to-be-estimated pixel, and comparing those pixels to get the location of the best pixel (integer pixel, half pixel, or quarter pixel) and the best macroblock type corresponding to the to-be-estimated pixel to further get the best MV of the to be-processed macroblock; and d) repeating the steps b) and c) for the next to-be-estimated pixel and its corresponding macroblock.

### BRIEF DESCRIPTION OF THE DRAWINGS

FIG. 1 is a schematic view of a preferred embodiment of the present invention, illustrating different sizes of respective macroblocks and corresponding modes thereof.

FIG. 2 is a block diagram of the preferred embodiment of the present invention, illustrating the interrelationships among modules in a chip.

FIG. 3 is a flow chart of the preferred embodiment of the present invention, illustrating the process of determining a search mode of a macroblock.

FIG. 4 is a schematic view of the preferred embodiment of the present invention, illustrating the location of each pixel with a predetermined search range.

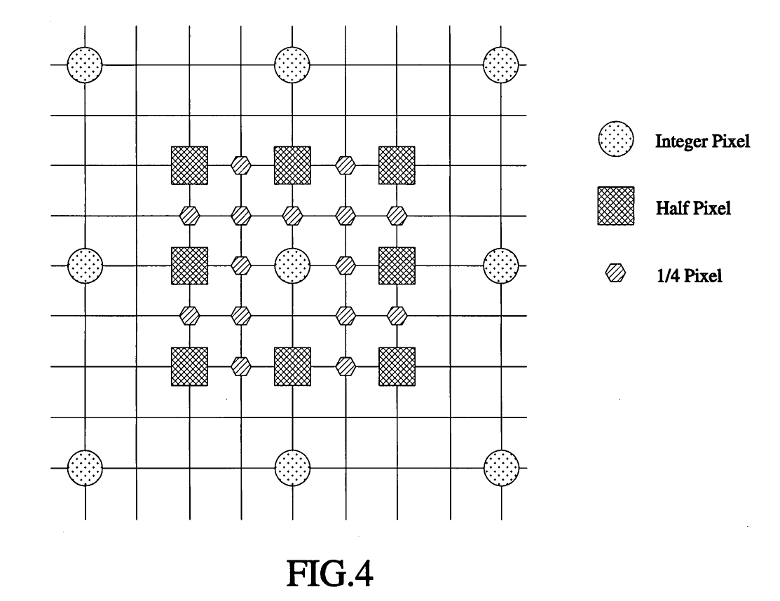

### DETAILED DESCRIPTION OF PREFERRED EMBODIMENTS

To specify the technical features of the present invention, the following preferred embodiment is recited in view of accompanying drawings.

In the H.264/AVC encoding, the fractional motion estimation needs to search 41 different blocks. After a simulated analysis in this regard, the present inventor became aware that 16×16 macroblocks selected after a search for the macroblocks in a film are the highest in ratio. In different films, the probability of selecting the 16×16 macroblocks is approximately 70-90%.

The present invention comes up with an adaptive mode selection technique characterized in that the correlation between a macroblock and an adjacent macroblock thereto is analyzed to conclude that the chances of the current macroblock selected to be 16×16 mode are more than 85%, and the chances of the current macroblock selected to be 16×16 mode, 16×8 mode, or 8×16 mode are close to 95%, as two adjacent upper and left macroblocks to be encoded each are 16×16 mode. If the result of the integer pixel motion estimation is analyzed, when the estimated optimal mode is 16×16 and the upper and left macroblocks each are 16×16 mode, the chances of the current macroblock selected to be 16×16 mode will rise up to more than 90%, and the chances of the current macroblock selected to be 16×16 mode, 16×8 mode, or 8×16 mode will be more than 96%.

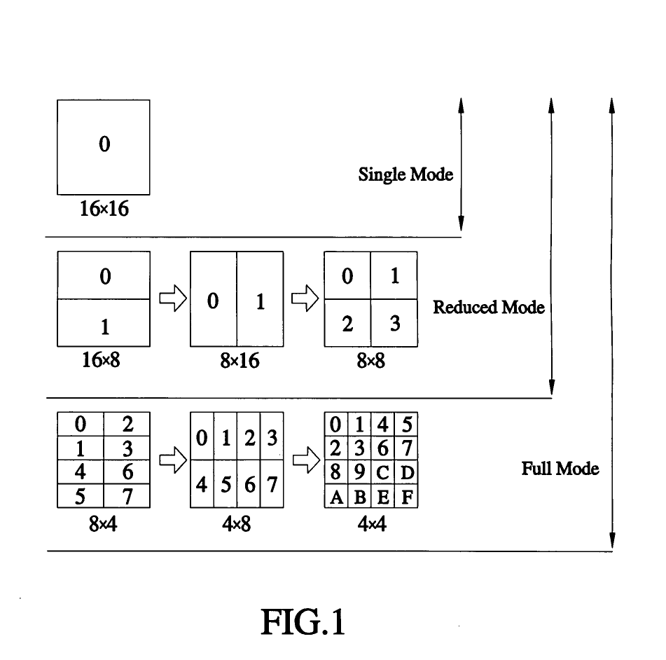

Referring to FIG. 1, a fractional motion estimation method with adaptive mode selection in accordance with a preferred embodiment of the present invention includes the following steps recited below.
a) Categorize search modes of the macroblock into a single mode, a reduced mode, and a full mode. Only 16×16 blocks are searched in the single mode, only 16×16 blocks, 16×8 blocks, 8×16 blocks and 8×8 blocks are searched in the reduced mode, and 16×16 blocks, 16×8 blocks, 8×16 blocks, 8×8 blocks, 8×4 blocks, 4×8 blocks, and 4×4 blocks are searched in the full mode. Each of the blocks is composed of a plurality of integer pixels. For example, a 4×4 block is composed of 16 integer pixels
b) Determine a search mode for a to-be-processed macroblock according to a predetermined condition as follows.
   (1) Select the single mode if the best mode of the integer pixel motion estimation of the to-be-processed macroblock is 16×16 and the mode of its predetermined adjacent macroblock is 16×16;
   (2) Select the reduced mode if the best mode of the integer pixel motion estimation of the to-be-processed macroblock is not 16×16 and the mode of its predetermined adjacent macroblock is 16×16;
   (3) Select the reduced mode if the best mode of the integer pixel motion estimation of the to-be-processed macroblock is one of 16×16, 16×8, and 8×16 modes and the mode of its predetermined adjacent macroblock is one of 16×16, 16×8, and 8×16 modes; or
   (4) Select the full mode if the best mode of the integer pixel motion estimation of the to-be-processed macroblock and the mode of its predetermined adjacent macroblock are both different from the aforesaid three conditions.

The predetermined adjacent macroblocks indicate the macroblocks located at the upper side and the left side of the to-be-processed macroblock separately.

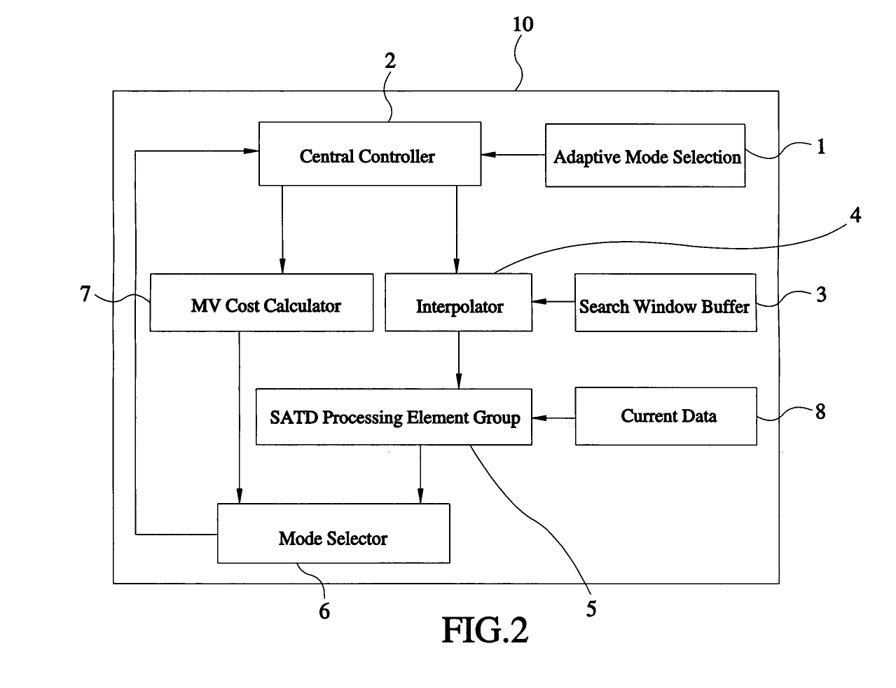

The practical operation can proceed as shown in FIG. 2.
(1) First, identify the type of the left macroblock. If it is smaller than 8×8, then the full mode will be determined.
(2) If the type of the left macroblock is larger than or equal to 8×8, identify the type of the upper macroblock. If the type of the upper macroblock is smaller than 8×8, the full mode will be determined.
(3) If both the types of the left and upper macroblocks are 16×16 and the integer pixel motion estimation concludes 16×16, the single mode will be determined.
(4) If both the types of the left and upper macroblocks are both 16×16 and the integer pixel motion estimation does not conclude 16×16, the reduced mode will be determined.
(5) If the types of the left and upper macroblocks both are smaller than 16×16 and larger than or equal to 8×8, and what the integer pixel motion estimation concludes is smaller than 16×16 and larger than or equal to 8×8, the reduced mode will be determined.
(6) If the types of the left and upper macroblocks both are smaller than 16×16 and larger than or equal to 8×8, and what the integer pixel motion estimation concludes is smaller than 8×8, the full mode will be determined.
c) Conduct a fractional motion estimation of a to-be-estimated pixel according to the search mode determined in the step b). The fractional motion estimation can be done by accessing a pixel located in a reference, i.e. the previous image of the current to-be-estimated pixel, and corresponding to the to-be-estimated pixel, performing an interpolation computation of such two pixels to get a half pixel and a quarter pixel, calculating the SATD and the MV cost of each of the pixels (integer pixel, half pixel, and quarter pixel), within a predetermined search range corresponding to the to-be-estimated pixel, and comparing those pixels to get the location of the best pixel (integer pixel, half pixel, or quarter pixel) and the best macroblock type corresponding to the to-be-estimated pixel to further get the best MV of the to be-processed macroblock.

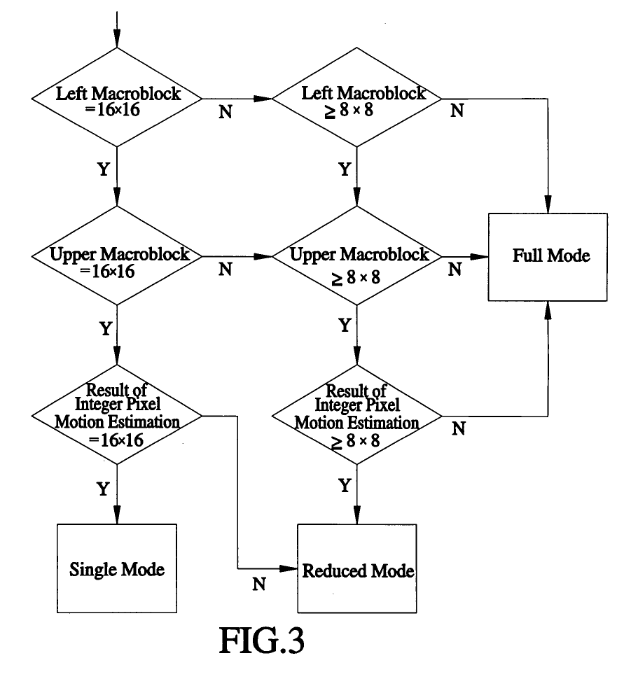

The aforesaid predetermined search range, as shown in FIG. 3, indicates the coverage including the to-be-estimated pixel and 8 half pixels and 16 quarter pixels therearound, namely, 25 pixels in total.

The aforesaid way to get the best pixel is to add up the SATD and the MV cost of each pixel and to compare respective sums of the SATD and the MV cost of those pixels, wherein a pixel of the minimal sum is the best pixel.

d) Repeat the steps b) and c) for another (next) to-be-estimated pixel and its corresponding macroblock.

The operations mentioned in the above-identified steps a) to d) can be based on the hardware architecture indicated in FIG. 2, in which the largest frame defined by the outmost border indicates a chip 10 and each block within the largest frame indicates one of function modules of the chip 10. The function modules includes an adaptive mode selection 1, a central controller 2, a search window buffer 3, an interpolator 4, an SATD processing element group 5, a mode selector 6, an MV cost calculator 7, and current data 8. The adaptive mode selection 1 can determine the search mode for every macroblock. After the search mode is determined, the central controller 2 can carry out relevant operation and computation. The search window buffer 3 can store each to-be-estimated pixel in need of fractional motion estimation. The interpolator 4 can access the reference, i.e. the previous image, from the search window buffer 3 for interpolation computation to get a half pixel and a quarter pixel. The SAID processing element group 5 can acquire the data of the current to-be-processed macroblock from the current data 8, figure out the SATD of each pixel (integer pixel, half pixel, or quarter pixel) within the predetermined search range in the aforesaid reference, and transmit those SATDs to the mode selector 6. The MV cost calculator 7 can figure out the MV cost for each pixel within each predetermined search range and then transmit it to the mode selector 6. The mode selector 6 can add up the SATD and the MV cost of each pixel and then compare the sums of the SATD and the MV cost of all of the pixels to get the best pixel and the best macroblock type.

Briefly, the present invention can analyze the macroblocks to define the three search modes. The left and upper macroblocks and the integer pixel motion estimation can be used for identifying which search mode is proper, belonging to an adaptive mode selection technique, whereby some parts of the computation can be spared to decrease throughput of the computation. In conclusion, the present invention can effectively enhance the efficiency of hardware and decrease the power consumption while maintaining constant image quality.

Although the present invention has been described with respect to a specific preferred embodiment thereof, it is in no way limited to the specifics of the illustrated structures but changes and modifications may be made within the scope of the appended claims.

What is claimed is:

1. A fractional motion estimation method with adaptive mode selection, comprising steps of:
a) categorizing search modes of macroblocks into a single mode, a reduced mode, and a full mode; only 16×16 blocks are searched in the single mode, the searches for 16×16 blocks, 16×8 blocks, 8×16 blocks and 8×8 blocks can be done in the reduced mode, and searches for 16×16 blocks, 16×8 blocks, 8×16 blocks, 8×8 blocks, 8×4 blocks, 4×8 blocks, and 4×4 blocks can be done in the full mode, each of the blocks being composed of a plurality of integer pixels; in the 4×4 blocks as an example, there are 16 integer pixels;
b) determining a search mode for a to-be-processed macroblock according to a predetermined condition; select the single mode if the best mode of the integer pixel motion estimation of the to-be-processed macroblock is 16×16 and the mode of its predetermined adjacent macroblock is 16×16; select the reduced mode if the best mode of the integer pixel motion estimation of the to-be-processed macroblock is not 16×16 and the mode of its predetermined adjacent macroblock is 16×16; or (3) select the reduced mode if the best mode of the integer pixel motion estimation of the to-be-processed macroblock is one of 16×16, 16×8, and 8×16 modes and the mode of its predetermined adjacent macroblock is one of 16×16, 16×8, and 8×16 modes; or select the full mode if the best mode of the integer pixel motion estimation of the to-be-processed macroblock and the mode of its predetermined adjacent macroblock are both different from the aforesaid three conditions;
c) conducting a fractional motion estimation of a to-be-estimated pixel according to the search mode determined in the step b); the fractional motion estimation can be done by accessing a pixel located in a reference and corresponding to the to-be-estimated pixel, performing an interpolation computation of such two pixels to get a half pixel and a quarter pixel, calculating the SATD and the MV cost of each of the pixels (integer pixel, half pixel, and quarter pixel) within a predetermined search range corresponding to the to-be-estimated pixel, and comparing those pixels to get the location of the best pixel (integer pixel, half pixel, and quarter pixel) and the best macroblock type corresponding to the to-be-estimated pixel to further get the best MV of the to be-processed macroblock; and
d) repeating the steps b) and c) for the next to-be-estimated pixel and its corresponding macroblock.

2. The fractional motion estimation method as defined in claim 1, wherein the predetermined search range in the step c) indicates the coverage including 8 half pixels and 16 quarter pixels around the to-be-estimated pixel and the to-be-estimated pixel itself, namely, 25 pixels in total.

3. The fractional motion estimation method as defined in claim 1, wherein the reference in the step c) indicates a previous image of the current to-be-estimated pixel.

4. The fractional motion estimation method as defined in claim 1, wherein the best pixel is of the minimal sum after the SATD and the MV cost of each pixel is added up and respective sums of the SATD and the MV cost of those pixels are compared.

5. The fractional motion estimation method as defined in claim 1, wherein the predetermined adjacent macroblock indicates two macroblocks located at the upper side and the left side of the to-be-processed macroblock respectively.
